(19) United States
(12) Patent Application Publication
(10) Pub. No.: US 2008/0033902 A1
(43) Pub. Date: Feb. 7, 2008

(54) A Method for Providing Live File Transfer Between Machines

(75) Inventors: Ari Brian Glaizel, Vaughan (CA); Tony Ponzo, Toronto (CA); Eliyahu Juni, Toronto (CA); Stephen Pollack, Toronto (CA)

Correspondence Address: INTEGRAL INTELLECTUAL PROPERTY INC., 1370 DON MILLS ROAD, SUITE 300, TORONTO, ON, M3B 3N7, US

(73) Assignee: PLATESPIN LTD, Toronto, ON (CA)

(21) Appl. No.: 11/462,435

(22) Filed: Aug. 4, 2006

(51) Int. Cl. G06F 17/30

(52) U.S. Cl. 707/1

(57) ABSTRACT

The present invention is directed to a system and method for transferring operating systems, applications and data between a source machine and a target machine while the source machine is running. Attempting to do so introduces the problem of attempting to transfer files that may be in use or “live”, as such they will be locked by another process during the transfer. The present invention addresses the problem of transferring locked files and ensuring the most current version is transferred to the target machine.

### BACKGROUND OF THE INVENTION

Computing systems are growing rapidly in size and complexity. Many businesses have data centers consisting of a multitude of servers. In such an environment servers will have different configurations of hardware and software, including operating systems.

One of the problems in managing a data center is moving an Operating System, related applications and data between servers to provide optimal use of the servers. A solution to this problem has been described in US Patent Application Publication No. 2006-0089995, entitled “System for Conversion Between Physical Machines, Virtual Machines and Machine Images”, published Apr. 27, 2006, which is assigned to the owner of the present application and which is incorporated by reference.

One issue in moving software and data between machines is that of “live file transfer”. The phrase live file transfer is meant to describe the ability to transfer files from a source machine without the need to shutdown and reboot to an under-control state. It also incorporates the issue of moving software and data between machines, some files may be in use (i.e. live) and thus unable to be transferred between machines by simply copying a file.

### SUMMARY OF THE INVENTION

The present invention is directed to a solution to obviate the problems encountered with live file transfer issues.

The present invention is directed to a method for live file transfer, between a source machine and a target machine said method comprising the steps of:

a) selecting a file from said source machine;

b) if said file is not locked copying said file to said target machine;

c) if said file is locked determining where the bytes of said file reside on said source machine and creating a reconstructed file based on said determining, then copying said reconstructed file to said target machine;

d) recording information on said copying in a temporary file; and

e) repeating steps a) to d) until all files on said source machine have been copied to said target machine.

The present invention is also directed to a system for live file transfer, between a source machine and a target machine said system comprising:

a) means for selecting a file from said source machine;

b) means for copying said file to said target machine;

c) means for recording information on said copying in a temporary file; and

d) means for determining all files on said source machine have been copied to said target machine.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram illustrating the conversions between machines;

FIG. 2 is a block diagram of a system utilizing an embodiment of the present invention;

FIG. 3 is a block diagram of a data center; and

FIGS. 4a, 4b, 4c, 4d and 4e are flowcharts illustrating the functionality of an embodiment of the present invention.

### DETAILED DESCRIPTION OF EMBODIMENTS OF THE INVENTION

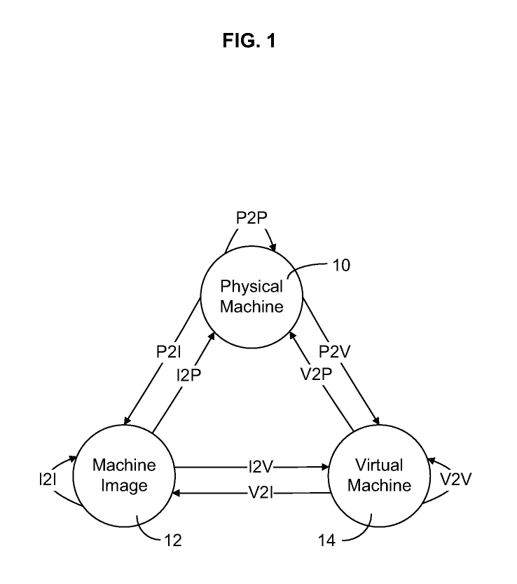

In order for the reader to understand how an embodiment of the present invention may be utilized we refer first to FIGS. 1 to 3 which describe a system that may utilize the present invention.

Referring first to FIG. 1 a block diagram illustrating the conversions between machines is shown. There are three types of machines, Physical 10, Image 12 and Virtual 14. Physical machines 10 are servers upon which an operating system and its related software applications run. Machine Images 12 are stored copies of the state of a physical machine 10 or a virtual machine 14 at a specific time. Virtual machines 14 emulate a specific environment and run on virtual machine server software. For example, some virtual machines 14 may run on a version of Linux, others on versions of Windows. Through the use of virtual server software such as ESX and GSX provided by VMware Inc., and Microsoft Virtual Server (hereinafter referred to as MSVS), multiple virtual machines 14 may be deployed on a physical machine 10. Other virtual machines such as Xen, which is open source, Virtual Iron and SW-Soft may also be supported by the present invention. The conversion from a physical machine 10 (P) to a virtual machine 14 (V) is referred to as P2V. Similarly the conversion from a virtual machine 14 (V) to a machine image 12 (I) is referred to as V2I. In general X is used whenever the source or target is independent of the type of source or target. For example I2X refers to a conversion from a machine image to any other type, physical, virtual or image. In total there are nine possible conversion types as shown in FIG. 1. The intent of FIG. 1 is to illustrate that any machine may be converted from one to the other.

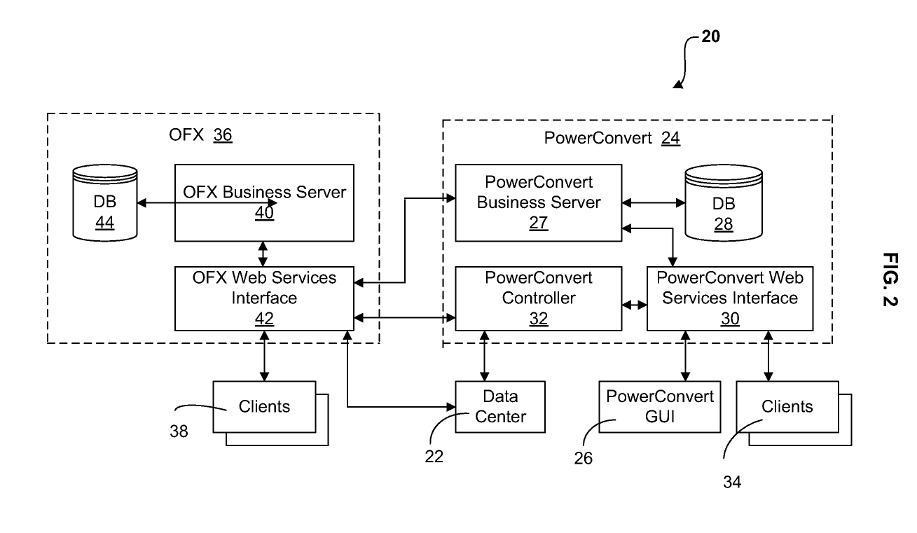

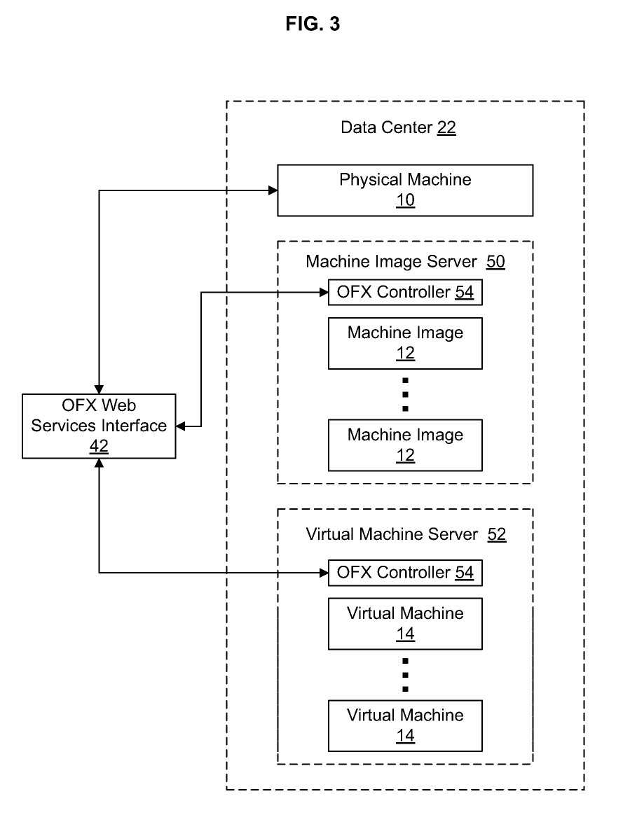

Referring next to FIG. 2, a block diagram of a system utilizing an embodiment of the present invention is shown generally as 20. Data center 22 is where the machines reside and is shown in greater detail in FIG. 3. In managing data center 22 a user may wish to move operating systems, applications and data between machines 10, 12, and 14 depending on the addition of new servers, load balancing and disaster recovery. For example it may be determined that a virtual machine 14 would run more efficiently on a different physical machine 10. Machine images 12 allow for the state of a physical machine 10 or a virtual machine 14 to be backed up and restored as needed. A machine image 12 is stored on an image server, which serves as a host for the image. The only difference between a machine image 12 land a virtual machine 14 is that the machine image 12 may not be started. To start a machine image 12 it must be moved to either a physical machine 10 or a virtual machine 14.

The conversion between machines is directed by PowerConvert 24. PowerConvert 24 resides on a server and has a distinct URL. Through the use of a PowerConvert Graphical User Interface (GUI) 26, a user may manage the movement of operating systems, applications and data between machines 10, 12 and 14 residing in a network of machines shown as data center 22. PowerConvert 24 obtains information on machines within data center 22 as selected by the user through GUI 26 and allows the user to move operating systems, applications and data between machines.

PowerConvert 24 comprises four main components: PowerConvert Business Server 27, Database 28, PowerConvert Web Services Interface 30, and PowerConvert Controller 32. PowerConvert Business Server 27 handles all requests to convert from a source machine to a target machine. In database 28 it stores archived operations and device driver information necessary when converting a machine. Users and client applications 34 communicate with the PowerConvert Business Server 27 through PowerConvert Web Services Interface 30. In one embodiment PowerConvert Web Services Interface 30 utilizes Simple Object Access Protocol (SOAP) over Hypertext Transfer Protocol (HTTP) to provide a standard interface. PowerConvert Controller 32 is an instance of an OFX controller 54 (see FIG. 3), but its role is specialized. It is responsible for running discovery jobs, and jobs that guide the overall conversion process, which includes deploying other controllers to remote machines, when necessary. Primarily, it is responsible for handling any requests to PowerConvert 24 that cannot be fulfilled synchronously in the time of a typical http request/response.

OFX 36 controls and reports on the jobs requested by PowerConvert 24 and client applications 38. OFX 36 resides on a server and has a distinct URL. In essence OFX is a generic job management engine that remotely executes and monitors jobs through OFX controllers 54 (see FIG. 3). Applications such as PowerConvert 24 can utilize OFX functionality. The core of OFX 36 is OFX Business Server 40, which remotely executes and monitors the jobs through OFX controllers. OFX Business Server 40 is passive; it is a web server and responds to communication from OFX Web Services Interface 42. In one embodiment OFX Web Services Interface 42 utilizes Simple Object Access Protocol (SOAP) over Hypertext Transfer Protocol (HTTP) to provide a standard interface. OFX Business Server 40 stores all information on requests, the status of requests and machine configuration information in a database 44. In operation OFX Business Server 40 receives information on the status of request from OFX Web Services Interface 42 through OFX controllers 54 (see FIG. 3) installed on machines in data center 22.

Referring now to FIG. 3, a block diagram of a data center 22 is shown. Data center 22 is a repository of various types of machines in various numbers. In the example shown there is a physical machine 10, a machine server 50 hosting a plurality of machine images 12 and a virtual machine server 52 hosting a plurality of virtual machines 14. A machine image server 50 is a computer that controls the storage of a number of machine images 12. A virtual machine server 52 is a computer running virtual server software such as MSVS, ESX, or GSX. Through the use of virtual server software, multiple virtual machines 14 may exist. Generically, a machine container is either a machine image server 50 or a virtual machine server 52. Also, the term contained machine is used when making reference to either a virtual machine or a machine image.

PowerConvert 24 is a fully automated solution for OS portability. That is PowerConvert 24 can move the entire contents of a machine, including its operating system, applications and data to another machine. PowerConvert 24 will convert a source machine to a target machine. As discussed earlier, the types of source and target machines are Physical (P), Virtual (V), and Image (I). The steps required for each of the nine possible conversion types are illustrated in Table 1 below. Note that the first four rows refer to discovery steps. Discovery steps are prerequisites to the conversion taking place. If the desired source and target machines cannot be discovered, the conversion will not take place.

Depending on the source machine and the target machine types used in a conversion, the actual steps used in the conversion process differ. Typically, either a step can be omitted because it is not needed, or a different step needs to be inserted because of the special processing involved for that conversion type.

There are some prerequisites before the conversion can begin. First, the appropriate source and target machines must be discovered. Next, the user must initiate and configure the parameters that define the conversion process. By default, the target machine will be configured with essentially the same properties as the source machine. This includes the hostname, amount of RAM, network configuration, number and sizes of disks, and other information. Using PowerConvert GUI 26, the user then modifies the configuration of the target machine to suit their needs. This may include changing the hostname or changing the memory size of the target machine.

The conversion process is defined in a set of OFX jobs and actions that run on various OFX controllers 54 installed on machines throughout the data center.

The conversion process is guided by a job running on PowerConvert Controller 32. Each action (or step) in the job is run in sequence. PowerConvert Controller 32 cannot be expected to perform the entire conversion process, since the conversion is almost always distributed among several machines in the data center. Whenever the ‘next’ step in the conversion process needs to be run on a remote machine (for example, an ESX server on which a virtual machine will be created), it is the responsibility of the job running on PowerConvert Controller 32 to schedule the appropriate job to run on the appropriate OFX controller 54 (see FIG. 3). It does this by calling OFX 36.

Table 1 below indicates which steps need to be executed for the given conversion type.

TABLE 1
Discovery and PowerConvert Steps

| Description | P2V | V2V | I2V | P2I | V2I | I2I | P2P | V2P | I2P |
|---|---|---|---|---|---|---|---|---|---|
| Discover Source | x | x | | x | x | | x | x | |
| Discover Source | | | x | | | x | | | x |
| Machine Container | | | | | | | | | |
| Discover Target | x | x | x | x | x | x | | | |
| Machine Container | | | | | | | | | |
| Discover Physical | | | | | | | x | x | x |
| Target | | | | | | | | | |
| Install Controller on | | | x | | | x | | | x |
| Source Machine | | | | | | | | | |
| Container if necessary | | | | | | | | | |
| Install Controller on | x | x | x | x | x | x | | | |
| Target machine | | | | | | | | | |
| Container if necessary | | | | | | | | | |
| Create VM | x | x | x | | | | | | |
| Take Control of Target | x | x | x | | | | | | |
| Machine | | | | | | | | | |
| Create Volumes on | x | x | x | | | | x | x | x |
| Target | | | | | | | | | |
| Take Control of Source | x | x | | x | x | | x | x | |
| Machine | | | | | | | | | |
| Copy Volumes from | x | x | x | x | x | x | x | x | x |
| Source to Target | | | | | | | | | |
| Prepare OS to boot | x | x | x | | | | x | x | x |
| Restart Target | x | x | x | | | | x | x | x |
| Configure OS in Target | x | x | x | | | | x | x | x |
| Restart Source Machine | x | x | | x | x | | x | x | |
| (optional) | | | | | | | | | |

When PowerConvert 24 has been instructed to perform a conversion from a source machine to a target machine, it needs to provide instructions to and receive status information from those machines. This is done through OFX 36 via OFX Web Services Interface 42.

A user through the use of PowerConvert GUI 26, or an application through clients 34, opens a discover machine dialog and provides the machine identification such as a hostname or IP address and their credentials. This results in a job being scheduled on PowerConvert controller 32 to discover the information about the source machine. Once complete the information collected is forwarded to OFX 36 and stored in database 44. The discovery gathers all the necessary information needed for a conversion, as well as some other information that may be useful to the user. The information includes all of the machine's components: processors, disks, network adapters, the amount of memory on the machine, details about the operating system, and the network connections.

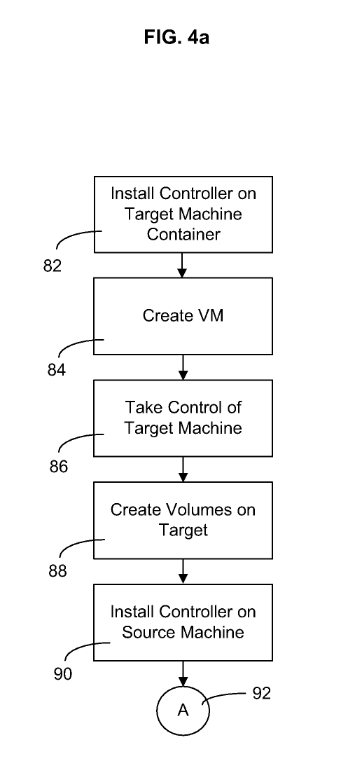

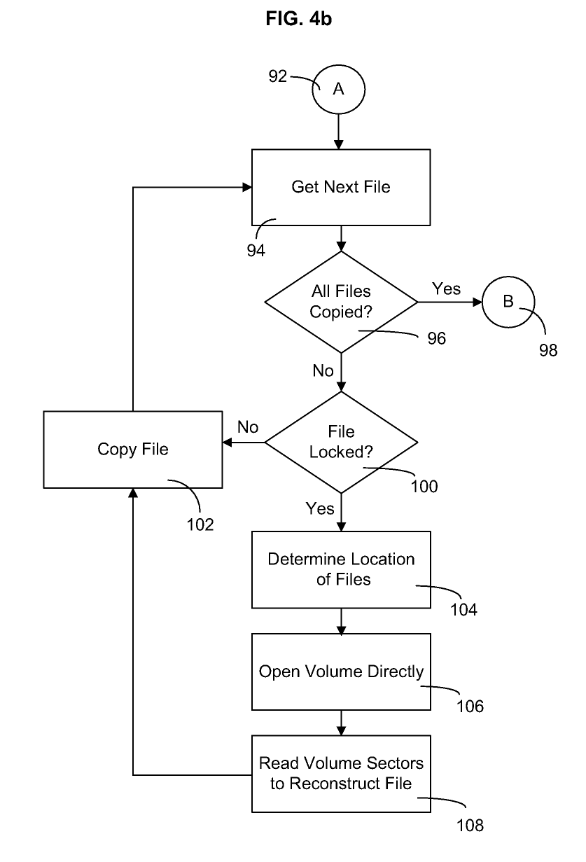

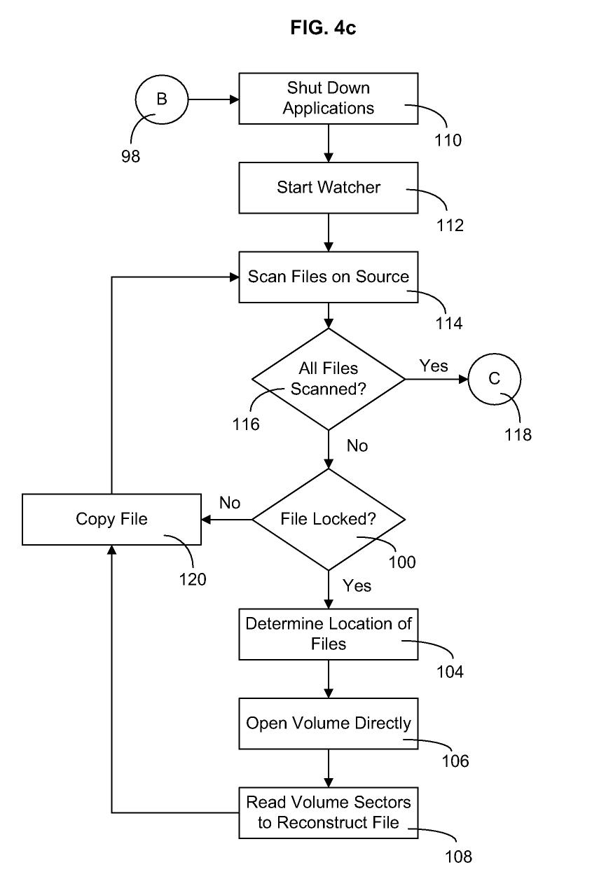

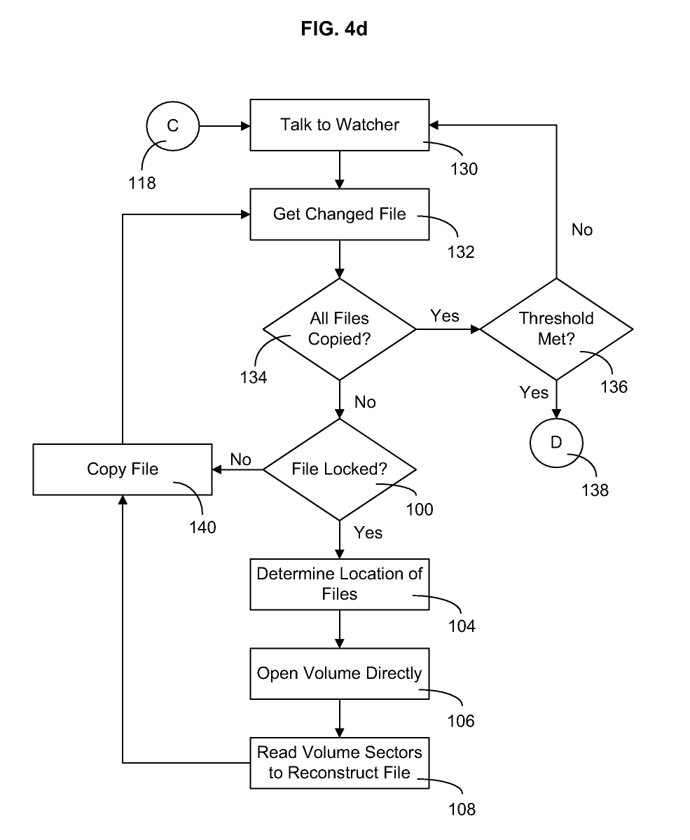

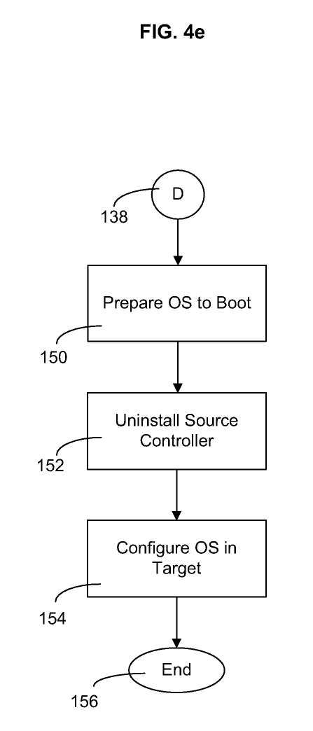

FIGS. 4a, 4b, 4c, 4d and 4e are flowcharts illustrating the functionality of an embodiment of the present invention. In this embodiment the invention is utilized by PowerConvert 24. It is not the intent of the inventors to restrict the use of embodiments of the present invention, rather FIGS. 4a, 4b, 4c and 4d simply serve as an example of how it may be utilized.

Beginning at step 82, if the target machine is a virtual machine 14 or a machine image 12, then PowerConvert 24 manages these machines by running jobs on the host Virtual machine server 52 (e.g., ESX, GSX or MSVS) or the Machine Image Server 50. Thus, an OFX controller 54 must be deployed to the host machine container. If the host machine container already has an OFX controller 54 installed on it from an earlier conversion, then this step can be skipped.

Next is step 84. This step only needs to run in the case of converting to a virtual machine. When the target machine is a virtual machine, PowerConvert 24 runs a job on the host of the virtual machine server 52 to create and manage a virtual machine 14. Each type of virtual machine server 52 provides its own API that can be used to create and manage one of its virtual machines. The PowerConvert actions running in the jobs make calls to the virtual machine server 52 through the available API's.

By default, the properties of a virtual machine 14 are set to reflect the properties of the source machine. While configuring the conversion in the PowerConvert GUI 26, the user has the option to adjust many of the properties of the new virtual machine 14 to make optimal use of the resources available. The following properties of a virtual machine 12 may be configured:
a) The display name (as used by the virtual machine server)
b) Memory (RAM)
c) Minimum memory size
d) Memory shares
e) Number and size of the hard disks
f) Hard disk controller types (IDE or SCSI)
g) Number of CPUs
h) CPU min and max, shares and affinity
i) Number of NICs and the mapping to a virtual adapter

### Finally, the new virtual machine 14 is registered with the virtual machine server 52.

We now move to step 86. This step is run only in the case of conversion to a virtual machine. A virtual machine 14 has been created, but it cannot run because there is no operating system installed on the machine yet.

The OFX controller 54 on the virtual machine server 52 is responsible for running this job. In this job, the newly created virtual machine is modified so that it connects to a virtual CDROM, which contains a copy of the boot image (WinPE or Linux Ramdisk). Then the virtual machine is forced to reboot. When the machine restarts, it will boot from the CDROM. The boot image will load, and a OFX controller 54 will be installed and configured

There is no need to take control of a target physical machine during the conversion process, since this already happens during the discovery stage when the machine is booted from the CDROM.

Moving next to step 88, now that the VM has been created and is under the control of PowerConvert 24, disk partitions and volumes are created.

Moving next to step 90, an OFX controller is installed on the source machine.

After step 90 the source and target machines are ready to begin copying. Before describing the details of an implementation of the copying process we will first provide an overview of how an embodiment of the present invention may be used in copying files, applications and operating systems between machines, which is described in detail with reference to FIGS. 4b, 4c, and 4d.

For live file transfer, if the target machine is a physical or virtual machine, it is running under control. That is, it is running within a boot image, with a controller configured. If the target machine is a machine image, then the controller of the machine container's host is used. In any case, there are two controllers ready to handle the copying of files. A ‘copy source’ job is scheduled to run on the source machines controller, and a ‘copy target’ job is scheduled to run on the target machine's controller. In the jobs, one side binds to a network port and waits for a connection from the other side. Either the source or the target may be configured to listen on a port. Once a connection is made, the transfer can begin.

PowerConvert 24 uses a file-based copy process. The source side begins with the root folder of a given volume and traverses the file system reading each file and folder. As each file and folder is found, the source side writes it to the socket connection. The data is streamed across the network in an OFX Package format. An OFX package is a binary format that is used for file distribution. It is similar in notion to a .tar file or a .zip file.

On the target side, the OFX Package is read from the network connection, one file at a time. As each new file arrives, it is recreated on the target machine with all of its associated properties. The intention is to recreate each file and folder exactly as it was on the source machine. The file transfer continues for each volume that was specified by the user to be copied. The user has the option of choosing not to copy one or more volumes, if so desired. Further, some files are not copied from the source to optimize the amount of data to transfer taking into account what can be recreated by the operating system on the target.

As mentioned earlier, PowerConvert 24 uses a file-based copy process. That is, each individual file and folder is copied from the source to the target. The alternative to this is an image-based copy. In an image-based copy, the entire contents of a file system are read from the disk byte-by-byte, regardless of the structure of the file system.

There are several advantages to using a file-based copy instead of an image-based copy, as follows:
1. Resizing of volumes. At configuration time, the user may decide that the size of a volume on the source machine is not optimal for the target machine.

a) For example, the C: drive on a Windows source machine is 20 GB in size, and now near capacity. In this case, the corresponding volume on the target machine can be configured with an increased size of, say, 50 GB.

b) Similarly, a volume on the source may be underutilized. It may be sized at 120 GB, but only ever uses about 10 GB. In this case, the corresponding volume on the target machine can be configured with a smaller size of, say, 20 GB.
2. Automatic defragmentation of the file system on the target machine. Any file on the source machine may be fragmented. That is, its data is not stored contiguously on the disk. During PowerConvert's file transfer step, files are being written to the target's disk one file at a time, each file will naturally occupy the next available sectors of the disk, since the disk starts off with a clean file system.
3. Filtering specific files so that they are not copied or are changed during the copy process. Files that can be recreated without copying, such as the swap file for the Windows operating system need not be copied, which often saves 1 GB or more of data during file transfer.

The present invention makes use of three stages to implement the live transfer of files. These three stages are illustrated in flowcharts 4b, 4c, and 4d. Beginning at step 94 the volumes to be transferred are scanned and each file found is identified in turn to be copied. At step 96 a test is made to determine if all files have been copied. This is determined by step 94 indicating that all files have been copied. If so processing moves to transfer point 98 and continues as shown in FIG. 4c. If all files have not been transferred, processing moves to step 100 where a test is made to determine if the current file is locked (i.e. live or in use). If the file is not locked and can be opened for copying, processing moves to step 102 where the file is copied. At this step a date time stamp for each file copied along with the full path name are stored in a temporary file. Processing then returns to step 94.

If the file is locked and cannot be opened, processing moves to step 104 where information on the locked file to be copied is determined via API calls.

By way of example for the Microsoft New Technology File System (NTFS) a call would be made to the API FSCTL_GET_NTFS_VOLUME_DATA which provides attributes of the NTFS which are utilized to determine information on where the file resides. From the information retrieved from this call, a call is then made to FSCTL_GET_RETRIEVAL_POINTERS to obtain the Virtual Cluster Number (VCN) and Logical Cluster Number (LCN). From this information the following pseudo-code is executed.

```
For each VCN for a given file
    logicalOffset = LCN * volumeDataBuffer.BytesPerCluster;
    LONGLONG lengthInClusters = nextVCN − startingVCN;
    sectorsToRead = (lengthInClusters *
    volumeDataBuffer.BytesPerCluster)/
        volumeDataBuffer.BytesPerSector;
End
```

Based on the statistics calculated a handle to the volume is provided and through the use of an API call such as CreateFile, the volume containing the file is opened at step 106 and the bytes of the locked file are read from the disk at step 108 to reconstruct the file. Once the file has been reconstructed at step 108, processing returns to step 102 where the file is copied.

The above example on how to open a locked file in the NTFS system serves solely as an example of one embodiment. The point here being that alternative file systems such as those used by Linux have similar interfaces to extract information on where the bytes of a locked file may reside to allow for the copying of the locked file.

Referring now to FIG. 4c, these steps are executed after all files have been transferred as indicated by transfer point 98 of FIG. 4b. Beginning at step 110 specific applications may be shut down on the source machine in order to copy their files. Examples would be active applications, such as a database server where a database is regularly being updated. Although this prevents users from accessing the application during the transfer process it ensures that the data utilized by the application is in a consistent state at the time the file is transferred. Once the transfer is complete the application may be restarted if requested by the user when initiating the transfer process.

At step 112 a background process referred to herein as a “watcher” is started to look for any future changes to the file system during the remainder of the process. This is done in two ways:
1) By snapshot comparisons. At a point in time, the date time stamp on every file in the file system is checked and compared to the temporary file of copied files. If the values vary, the change is recorded in a list maintained by the watcher.
2) Through the use of an operating system API such as ReadDirectoryChangesW provided by Windows. This provides information at a given moment in time when a file has changed. This allows for the capture of information on deleted files, added files and modifications made to existing files which are also added to the list maintained by the watcher.

At step 114 the file system of the source system is scanned and for each file found a comparison is made to the entry in the temporary file created by step 102 of FIG. 4b. If the file has been modified or is new, the file is copied. Processing remains at step 114 until a file to be copied is located or all files have been scanned. At step 116 a test is made to determine if all files have been scanned, if this is the case, processing moves to step 118 a transfer point to FIG. 4d and the final stage of the live file transfer process. If all files have not been copied, step 114 has identified a file to be copied. At step 100 a test is made to determine if the file is locked. If so processing moves to step 104. Steps 100, 104, 106 and 108 are identical to those described with regard to FIG. 4b and have been given the same reference numbers. If the file is not locked processing moves to step 120 where the file is copied. Processing then returns to step 114. Similarly once step 108 completes, processing moves to step 120.

Referring now to FIG. 4d, these steps are executed after all files have been copied by the steps described in FIG. 4c. Beginning at step 130 the watcher started at step 112 of FIG. 4c is contacted to obtain a list of all files the watcher has determined to have been changed during the copying process of FIG. 4c. At this point a copy is made of the list from the watcher and the list created by the watcher is cleared so it may start providing entries for the next iteration. At step 132 each file in the list created by the watcher has changed so it will be copied. At step 134 a test is made to determine if all files have been copied, if so a test is made at step 136. Step 136 determines if a new list of changed files should be obtained from the watcher. It is the decision made at this step that terminates or continues the process illustrated in FIG. 4d. Any number of tests may be used, for example, is the change threshold, e.g. number of files changed from the last inspection of the list from the watcher sufficiently minor or empty so processing can end? Another example would be have a certain number of iterations been reached? If the threshold has not been met processing returns to step 130 where a new list of changed files is obtained from the watcher. If the threshold has been met, the file transfer is complete and processing moves to FIG. 4e via transfer point 138. Although the threshold parameters are predetermined, in one embodiment the user has the option of setting their own thresholds.

If at step 134 it is determined that all files have not been copied at step 100 a test is made to determine if the file is locked. If so processing moves to step 104. Steps 100, 104, 106 and 108 are identical to those described with regard to FIG. 4b and have been given the same reference numbers. If the file is not locked processing moves to step 140 where the file is copied. Processing then returns to step 132. Similarly once step 108 completes, processing moves to step 102.

Moving now to FIG. 4e, the file transfer process has ended. Beginning at step 150, PowerConvert 24 prepares the operating system to boot while it is still under control. It is only at this time that PowerConvert 24 has full access to the operating system of the target machine. The following steps are taken:
a) Update drivers. Device drivers are installed on the Operating System. The drivers installed are those that match the plug and play identification of the devices on the target machine, which are determined at machine discovery time. For devices such as mass storage devices, it is vital to update the drivers while the machine is under control, otherwise the machine may likely never be able to boot.
b) Update Hardware Abstraction Layer (HAL) and kernel files. HAL and kernel files are updated, if necessary.
c) Update boot configuration file (boot.ini or grub.conf or linux.conf) so that the new machine will boot from the appropriate partition.
d) Update hostname, as configured by the user.
e) Update network connections. At this time for Linux only; it needs to be done later for Windows.
f) Disable VMware tools, if necessary.
g) Disable MSVS additions, if necessary.
h) Update Windows services or Linux daemons, as configured by the user.

At step 152 the controller installed on the target machine at step 90 of FIG. 4a is uninstalled.

Step 154 only needs to run for Windows target machines. For Linux, the target machine is fully configured by the end of the Prepare OS to Boot step 150. This step runs within a small Windows service that is injected into the target earlier and does the following:
a) Restore mount points on volumes
b) Configure network connections
c) Generate new Session Id
d) Join a domain or workgroup, as configured by user
e) Restore NT4 file security

After completion of step 154 the conversion is complete and processing ends at step 156.

Although the embodiment of the present invention is directed to copying entire systems including operating systems, applications and data it may be utilized for copying only a subset of a file system. The example provided for use with a tool such as PowerConvert is meant to serve only as one valuable use of the live file transfer process as described.

It is to be noted that embodiments of the present invention do not require the installation of drivers, for example kernel drivers, file system drivers or device drivers on the source machine. In contrast, live file transfer utilizes the API's provided by the operating system to copy files.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. By way of example note that the inventors refer to the use of the Windows and Linux environments, specific VM products and specific tools such as WinPE and SSH. One skilled in the art will recognize that the present invention is structured to be portable across operating systems and easily adaptable to different computing environments and other virtual machine technology.

We claim:

1. A method for live file transfer between a source machine and a target machine, the method comprising the steps of:
a) selecting a file from said source machine;
b) if said file is not locked copying said file to said target machine;
c) if said file is locked determining where the bytes of said file reside on said source machine and creating a reconstructed file based on said determining, then copying said reconstructed file to said target machine;
d) recording information on said copying in a temporary file; and
e) repeating steps a) to d) until all files on said source machine have been copied to said target machine.

2. The method of claim 1 further comprising the steps of:
f) scanning each entry in said temporary file to determine if changes have been made to said file since said file was copied;
g) if changes have been made to said file since said file was copied;
if said file is not locked copying said file to said target machine;
if said file is locked determining where the bytes of said file reside on said source machine and creating a reconstructed file based on said determining, then copying said reconstructed file to said target machine;
recording information on said copying in said temporary file; and
h) repeating steps f) to g) until all files that have been changed on said source machine have been copied to said target machine.

3. The method of claim 2 further comprising the step of shutting down one or more applications on said source machine.

4. The method of claim 2 further comprising the step of starting a watcher, said watcher creating a list for recording changes to files on said source machine as they occur.

5. The method of claim 4 further comprising the steps of:
i) for each file in the list created by said watcher;
if said file is not locked copying said file to said target machine;
if said file is locked determining where the bytes of said file reside on said source machine and creating a reconstructed file based on said determining, then copying said reconstructed file to said target machine; and
j) repeating step i) until a threshold has been met.

6. A system for live file transfer, between a source machine and a target machine said system comprising:
a) means for selecting a file from said source machine;
b) means for copying said file to said target machine;
c) means for recording information on said copying in a temporary file; and
d) means for determining all files on said source machine have been copied to said target machine.

7. The system of claim 6 further comprising:
e) means for scanning each entry in said temporary file to determine if changes have been made to said file since said file was copied;
f) means for copying said file if changes have been made to said file since said file was copied;
g) means for recording information on said copying in said temporary file; and
h) means for determining that all files that have been changed on said source machine have been copied to said target machine.

8. The system of claim 7 further comprising means for shutting down one or more applications on said source machine.

9. The system of claim 7 further comprising means for starting a watcher, said watcher creating a list for recording changes to files on said source machine as they occur.

10. The system of claim 9 further comprising:
i) means for copying the files in said list; and
j) means for determining if all files have been copied subject to meeting a threshold.

11. A computer readable medium comprising computer-executable instructions for performing steps comprising:
a) selecting a file from a source machine;
b) if said file is not locked copying said file to a target machine;
c) if said file is locked determining where the bytes of said file reside on said source machine and creating a reconstructed file based on said determining, then copying said reconstructed file to said target machine;
d) recording information on said copying in a temporary file; and
e) repeating steps a) to d) until all files on said source machine have been copied to said target machine.

12. The computer readable medium of claim 11, having further computer-executable instructions for performing the steps of:
f) scanning each entry in said temporary file to determine if changes have been made to said file since said file was copied;
g) if changes have been made to said file since said file was copied;
if said file is not locked copying said file to said target machine;
if said file is locked determining where the bytes of said file reside on said source machine and creating a reconstructed file based on said determining, then copying said reconstructed file to said target machine;
recording information on said copying in said temporary file; and
h) repeating steps f) to g) until all files that have been changed on said source machine have been copied to said target machine.

13. The computer readable medium of claim 12, having further computer-executable instructions for performing the step of shutting down one or more applications on said source machine.

14. The computer readable medium of claim 12, having further computer-executable instructions for performing the step of starting a watcher, said watcher creating a list for recording changes to files on said source machine as they occur.

15. The computer readable medium of claim 14, having further computer-executable instructions for performing the steps of:
i) for each file in the list created by said watcher;
if said file is not locked copying said file to said target machine;
if said file is locked determining where the bytes of said file reside on said source machine and creating a reconstructed file based on said determining, then copying said reconstructed file to said target machine; and
j) repeating step i) until a threshold has been met.
